(19) United States
(12) Patent Application Publication
(10) Pub. No.: US 2003/0054775 A1
(43) Pub. Date: Mar. 20, 2003

(54) Diplexer

(76) Inventors: Neil Scott Eaves, San Diego, CA (US); Randolph E. Standke, San Diego, CA (US)

Correspondence Address: QUALCOMM Incorporated, Attn: Patent Department, 5775 Morehouse Drive, San Diego, CA, 92121-1714, US

(21) Appl. No.: 09/956,435

(22) Filed: Sep. 18, 2001

(51) Int. Cl. H04B 1/44

(52) U.S. Cl. 455/80; 455/78

(57) ABSTRACT

A diplexer for providing an efficient, low cost, passive, reliable system and method for sharing a single antenna between a cellular subsystem and a GPS subsystem. The inventive diplexer includes first and second devices coupled to an input node for receiving a composite signal having first and second component signals at first and second frequencies respectively. In accordance with the invention, the first device passes the first signal and provides an open circuit to the second signal, while the second device passes the second signal and provides an open circuit to the first signal. In the illustrative embodiment, the first and second devices are first and second transmission lines respectively. The transmission lines may be of any type, i.e., microstrip, stripline, coplanar waveguide etc.

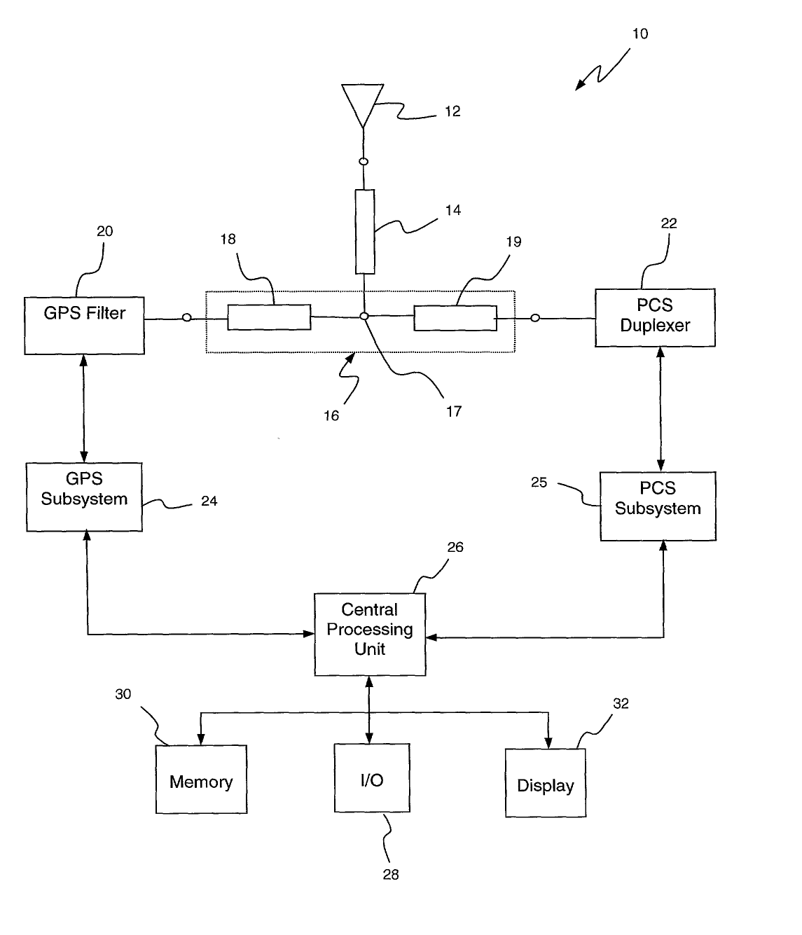

### BACKGROUND OF THE INVENTION

1. Field of the Invention

The present invention relates to electronic circuits and systems. More specifically, the present invention relates to diplexers for use in communication applications.

2. Description of the Related Art

Currently, there is an ongoing need to add additional features to cellular telephones. One feature currently under consideration relates to position location. That is, in response to U.S. Government mandates relating to the provision of emergency services, the cellular telephone industry is currently looking into a variety of systems and techniques for ascertaining the position of a user of a cellular telephone. One very promising approach involves a use of the Global Positioning System (GPS).

The GPS system consists of a constellation of low earth orbiting satellites that transmit signals in accordance with a highly accurate onboard clock. Signals received from three or more satellites by a receiver located on or near the surface of the earth are triangulated to provide a fix on location of the receiver.

While current proposals involve an integration of the GPS receiver into the electronic circuitry of a cellular phone, current designs call for the use of separate antennas for the cellular communications and GPS position location subsystems thereof.0

For numerous reasons, e.g. size, cost, weight, and consumer appeal, there was a need for a system or method for using a single antenna to effect communication to and from two or more separate transmitters or receivers in a cellular telephone or other system with a small form factor.

The need in the art was addressed by U.S. patent Application Ser. No. ______, filed ______, by Standke et al. and entitled GPS EQUIPPED CELLULAR PHONE WITH SINGLE SHARED ANTENNA, (Atty. Docket No. 000089) the teachings of which are incorporated herein by reference. Standke et al. disclose and claim a novel and advantageous system and method for sharing a single antenna in a cellular phone between a cellular subsystem and a GPS subsystem. In accordance with the teachings of the reference, a switch is used to select a cellular mode or a GPS mode of operation. The switch operates in response to a system controller via a switch driver. First and second matching networks are employed to provide for optimal performance for each mode of operation.

While this approach substantially addresses the need in the art, there are certain shortcomings associated with same. For example, the switch must be actuated. Hence, a switch driver must be provided. The driver must be powered. The controller must be programmed to provide the switch actuation signal and there are losses due to the presence of the switch. Finally, the switch is susceptible to failure.

While diplexers are known in the art, diplexers are not known to be available for operation at both cellular and GPS frequencies.

Accordingly, a need remains in the art for an efficient, low cost, passive, reliable system and method for sharing a single antenna between a cellular subsystem and a GPS subsystem.

### SUMMARY OF THE INVENTION

The need in the art is addressed by the diplexer of the present invention. Generally, the inventive diplexer includes first and second devices coupled to an input node for receiving a composite signal having first and second component signals at first and second frequencies respectively. In accordance with the invention, the first device passes the first signal and provides the equivalent of an open circuit to the second signal, while the second device passes the second signal and provides the equivalent of an open circuit to the first signal.

In the illustrative embodiment, the first and second devices are first and second transmission lines of appropriate length in front of first and second frequency selective components usually used in the products that only operates on one of these signals respectively. The transmission lines may be of any type, i.e., microstrip, stripline, coplanar waveguide etc.

The inventive diplexer provides an efficient, low cost, passive, reliable system and method for sharing a single antenna between a cellular subsystem and a GPS subsystem.

### BRIEF DESCRIPTION OF THE DRAWINGS

The FIGURE is a block diagram of an antenna sharing system with an illustrative embodiment of a diplexer implemented in accordance with the teachings of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The FIGURE is a block diagram of an antenna sharing system with an illustrative embodiment of a diplexer implemented in accordance with the teachings of the present invention. The system 10 includes a dual band antenna 12 adapted to operate at the frequencies of interest. In the illustrative embodiment, the antenna 12 is designed to perform within specification at both GPS (1575 MHz) and PCS (Personal Communication System) (1850-1990 MHz) frequencies.

The antenna 12 is connected to a diplexer 16, implemented in accordance with the present teachings, via a first segment of transmission line 14. The first segment of transmission line may be of any length. The diplexer 16 includes second and third segments of transmission line 18 and 19. The first transmission line segment 14 connects to a “T” junction 17. The two remaining ends of the T junction 17 are connected to the inputs of two filters provided by second and third transmission line segments 18 and 19 respectively. In the illustrative embodiment, the first, second and/or third transmission line segments or elements are constructed in any suitable manner known in the art, e.g., microstrip, stripline, coplanar waveguide, etc.

As discussed more fully below, the diplexer 16 extracts two separate signal components from a composite input signal (e.g., GPS/PCS or GPS/Cellular) received by the antenna 12. In accordance with the present teachings, the rejected signal is rotated in phase angle by the second and third transmission line segments to present an open circuit at the “T” junction 17 to the signals rejected thereby. That is, in the illustrative implementation, the second transmission line element 18 passes the GPS signal component and rotates the phase angle of the reflected CDMA (e.g., PCS) component so that it appears as an open circuit (since it has a phase angle near 0 degrees) at the “T” junction 17. The third transmission line element 19 passes the CDMA signal component and rotates the reflected phase angle of the GPS component so that it appears as an open circuit at the “T” junction 17.

The GPS signals output by the diplexer 16 are processed in a conventional manner by a GPS filter 20 and input to a GPS receiver 24. The PCS signals output by the diplexer 22 are provided to a duplexer 22 which splits the signal into transmit and receive components as is common in the art. The output of the PCS duplexer is provided to a PCS transceiver 25. The GPS receiver and the PCS transceiver operate under the direction of a central processing unit 26. The CPU 26 receives user input via interface 28 and communicates with a memory 30 and a display 32 in a conventional manner.

The diplexer 16 characterizes the S-Parameters of the filter for both of the desired frequency bands, allowing the out of band reflection coefficient and a length of transmission line to form the components of the diplexer. It should be noted that the out of band reflection coefficient of the first filter should be high at the passband of the second filter and the out of band reflection coefficient of the second filter should be high at the passband of the first filter.

The second transmission line 18 has its characteristic impedance matched to the input passband impedance of the GPS filter 20. As mentioned above, the length of the second transmission line 18 from the “T” junction to the input of GPS 20 filter is such that the PCS reflection coefficient is rotated to 0 degrees at the “T” junction. This represents an open circuit to the PCS frequencies at the “T” junction, while providing a good match to the GPS passband frequency.

The third transmission line segment 19 has its characteristic impedance matched to the input passband impedance of the PCS duplexer 22. The length of transmission line from the “T” junction to the input of PCS filter is such that the GPS reflection coefficient is rotated to 0 degrees at the “T” junction. This represents an open circuit to GPS frequencies at the “T” junction, while providing a good match at the PCS passband frequencies. This transformation to a 0-degree reflection coefficient at the “T” junction is equivalent to an open circuit for the first frequency, while allowing the second frequency a good match.

Those skilled in the art will appreciate that a portion of the signal traveling on a transmission line will be reflected when it encounters a component or other discontinuity on that transmission line, unless it is perfectly matched to the characteristic impedance of the transmission line. The reflection is specified by the reflection coefficient. The reflection coefficient has magnitude and an angle. The magnitude of the reflection coefficient T is the ratio of the voltage reflected to the voltage incident on the component. It has a range of 0 to 1. The reflection coefficient angle is the angle of the reflected signal relative to the incident signal. It has a range of 0-360 degrees. (Angle can also be specified by negative values. For example, 270 degrees=−90 degrees, 350 degrees=−10 degrees, 180 degrees=−180 degrees, etc.

In general, adding or subtracting 360 degrees from any angle is the same angle since it signifies a complete transition around a circle.”) For example, if the component were a short circuit, the reflection coefficient has a magnitude of 1, and an angle of 180 degrees (or −180 degrees). All of the signal is reflected and the phase is reversed. The reflection from an open circuit also has a magnitude of 1, but has an angle of 0 degrees. All of the signal is reflected but the angle is not changed. If a length of transmission line (with the same characteristic impedance as the system) is inserted between a discontinuity and the measurement point, the reflection magnitude at the measurement point remains the same, but the reflection angle changes by minus twice the electrical length of this inserted transmission line. This is because the inserted line delays both the time for the incident wave to travel to the discontinuity and the time for the reflected wave to return from the discontinuity. For example, the electrical length of a quarter wavelength transmission line in degree units is 90 degrees. If a 90 degree transmission line were inserted in front of a short circuit, it would add −180 degrees to the −180 degree reflection coefficient of the short circuit.

The reflection coefficient at the input of a 90 degree long transmission line with a short circuit at the other end has a magnitude of 1 and an angle of −360 degrees, which is equal to 0 degrees. This is exactly the same reflection coefficient as an open circuit. By the same method, any discontinuity with a reflection coefficient magnitude of 1 can be electrically equivalent to an open circuit (which is equivalent to removing it) with the appropriate length of transmission line in front of it.

Hence, in accordance with the present teachings, there are two objectives: 1) have the input impedance (as seen at the tee junction) of the line leading to the GPS filter appear as an open circuit over the phone frequency band and 2) have the input impedance of the line leading to the phone duplexer appear as an open circuit at the GPS frequency. This is done by adding the correct transmission line lengths to “rotate” the reflection coefficients to 0 degrees.

Even though the reflection coefficient angle of the GPS filter at the phone band and of the phone band duplexer at GPS band can be arbitrary, they have to remain consistent after the circuit is designed. These values must not change from production lot to production lot.

Method of Calculation

1. Measure input impedance of the GPS filter 20 (typically a 2-pole ceramic filter) with the reference plane extended to the filter. The frequency range is to include GPS (1.57542 GHz) and the phone band (i.e. 824-894 MHz for US cellular, 1.85-1.99 GHz for US PCS, etc.)

2. Measure the phone band duplexer (typically a multi pole ceramic filter) in the same way.

3. In this step we calculate the electrical length of the line (18) from the common junction to the GPS filter. The reflection magnitude of the GPS filter should be high in the phone band frequency. Note the reflection angle at the center of the phone band. The length of the transmission line between the common junction and the GPS filter rotates this reflection angle to zero degrees. The electrical length (in degrees) is equal to ½ the reflection angle of the GPS filter.

For example, assume the GPS filter 20 has a reflection angle of 168 degrees at the center of the PCS band. The electrical length of the transmission line required to rotate this reflection angle to 0 degrees is 168/2=84°. In other words, the electrical length is 84°/360° of a wavelength at the center of the PCS band (1.92 GHZ).

If this transmission line had an air dielectric, the length (in inches) would be:

84°/360°×11.80 GHz-inch (speed of light in English units)/1.92 GHz (freq.)=1.434 inches

If the transmission line was a microstrip line on an epoxy-glass substrate with a typical effective dielectric constant of 3.4, the line length would be

1.434/\sqrt{3.4}−0.777 inch.

4. The reflection magnitude of the phone duplexer should be high at GPS. In the same way used for the GPS filter, the reflection angle of the phone duplexer is rotated to zero degrees by the line length from the common junction to the duplexer.

For example, assume the PCS duplexer 22 has a reflection angle of 44° at GPS frequency. In accordance with the present teachings, the electrical length of line required at GPS frequency is 44°/2=22°. For a microstrip line such as the line to the GPS filter the length is:

(1/\sqrt{3.4})×22°/360°×11.80 GHz-inch/1.575 GHz=0.248 inch

where the first term (1/\sqrt{3.4}) is the length reduction factor relative to an air dielectric; the second term (22°/360°) is a fraction of a wavelength; and the third term 11.80 GHz-inch/1.575 GHz is the wavelength in air in inches.

5. Check for possible improvement by tuning using a circuit simulation program or other suitable method. Altering the line length calculated will add a shunt reactance at the T junction, instead of an open circuit. This may improve the match of the other band if it is not perfect.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A diplexer comprising:
first means coupled to an input node for receiving a composite signal having first and second component signals at first and second frequencies respectively and for passing the first signal and providing an open circuit to the second signal and
second means coupled to the input node for receiving the composite signal and passing the second signal and providing an open circuit to the first signal.

2. The diplexer of claim 1 wherein the first means and the second means are first and second transmission lines respectively.

3. The diplexer of claim 2 wherein the first and second transmission lines are microstrip transmission lines.

4. The diplexer of claim 2 wherein the first and second transmission lines are stripline transmission lines.

5. The diplexer of claim 2 wherein the first and second transmission lines are coplanar waveguides type transmission lines.

6. A communication system comprising:
an antenna;
a diplexer connected to the antenna, the diplexer having:
first means coupled to the antenna for receiving a composite signal having first and second component signals at first and second frequencies respectively and for passing the first signal and providing an open circuit to the second signal and
second means coupled to the antenna for receiving the composite signal and passing the second signal and providing an open circuit to the first signal;
a first circuit connected to the first means; and
a second circuit connected to the second means.

7. The communication system of claim 6 wherein the first means and the second means are first and second transmission lines respectively.

8. The communication system of claim 7 wherein the first and second transmission lines are microstrip transmission lines.

9. The communication system of claim 7 wherein the first and second transmission lines are stripline transmission lines.

10. The communication system of claim 7 wherein the first and second transmission lines are coplanar waveguides type transmission lines.

11. The communication system of claim 6 wherein the first circuit is includes cellular communications transceiver.

12. The communication system of claim 11 wherein the first circuit includes a PCS duplexer.

13. The communication system of claim 6 wherein the second circuit includes a position location data receiver.

14. The communication system of claim 13 wherein the position location data receiver is a Global Positioning System receiver.

15. The communication system of claim 13 wherein the first circuit includes a GPS filter.

16. A method for separating signals received from a shared antenna including the steps of:
first means coupled to the antenna for receiving a composite signal having first and second component signals at first and second frequencies respectively and for passing the first signal and providing an open circuit to the second signal and
second means coupled to the antenna for receiving the composite signal and passing the second signal and providing an open circuit to the first signal.
